(19) United States
(12) Patent Application Publication
(10) Pub. No.: US 2026/0118712 A1
(43) Pub. Date: Apr. 30, 2026

(54) DISPLAY DEVICE

(71) Applicant: AUO Corporation, Hsinchu City (TW)

(72) Inventors: Min-Hsuan Chiu, Hsinchu City (TW); Wei-Ming Cheng, Hsinchu City (TW); Chao-Min Yang, Hsinchu City (TW)

(73) Assignee: AUO Corporation, Hsinchu City (TW)

(21) Appl. No.: 18/974,810

(22) Filed: Dec. 10, 2024

(30) Foreign Application Priority Data
Oct. 30, 2024 (TW) 113141638

(51) Int. Cl. G02F 1/1335; G02F 1/13363

(52) U.S. Cl. CPC G02F 1/133512; G02F 1/133531; G02F 1/133607; G02F 1/133638

(57) ABSTRACT

Provided is a display device including a backlight module, a half wave plate, a viewing angle modulation layer, and a display panel stacked in sequence. The display panel includes a first polarizer, a pixel layer, and a second polarizer stacked in sequence. The first polarizer is disposed between the viewing angle modulation layer and the pixel layer. The backlight module includes a prism sheet, and the prism sheet includes a plurality of prism structures arranged along a first direction. The half wave plate has a slow axis, and the slow axis is parallel to a second direction. The first direction is not parallel to, and not perpendicular to, the second direction.

### CROSS-REFERENCE TO RELATED APPLICATION

This application claims the priority benefit of Taiwan application serial no. 113141638, filed on Oct. 30, 2024. The entirety of the above-mentioned patent application is hereby incorporated by reference herein and made a part of this specification.

### BACKGROUND

### Technical Field

The disclosure relates to an optical device, and particularly relates to a display device.

### Description of Related Art

The backlight source of the display panel has a significant difference between the intensity of vertical polarization and the intensity of horizontal polarization due to the structure of the internal film, in which the former may have 22% more intensity than the latter. In addition, the viewing angle modulation layer of the display panel is selective for the polarization direction, which has a viewing angle modulation function for horizontal polarization, and has almost no viewing angle modulation function for vertical polarization.

### SUMMARY

The disclosure provides a display device with high viewing angle modulation efficiency and high brightness.

According to an embodiment of the disclosure, provided is a display device, including a backlight module, a half wave plate, a viewing angle modulation layer, and a display panel stacked in sequence. The display panel includes a first polarizer, a pixel layer, and a second polarizer stacked in sequence. The first polarizer is disposed between the viewing angle modulation layer and the pixel layer. The backlight module includes a prism sheet, and the prism sheet includes multiple prism structures arranged along a first direction. The half wave plate has a slow axis, and the slow axis is parallel to a second direction. The first direction is not parallel to, and not perpendicular to, the second direction.

According to an embodiment of the disclosure, provided is a display device, including a backlight module, a half wave plate, a viewing angle modulation layer, a first polarizer, a pixel layer, and a second polarizer stacked in sequence. The first polarizer has a transmission axis, and the transmission axis is parallel to a first direction. Light provided by the backlight module has a first intensity and a second intensity before entering the half wave plate. The first intensity is an intensity of a first part of the light, and the second intensity is an intensity of a second part of the light. A polarization direction of the first part of the light is parallel to the first direction, a polarization direction of the second part of the light is parallel to a second direction, and the second direction is perpendicular to the first direction. A ratio of the second intensity to the first intensity is in a range of 1.23 to 2.34. The half wave plate has a slow axis, the slow axis is parallel to a third direction, and the first direction is not parallel to, and not perpendicular to, the third direction.

Based on the above, the display device provided by the embodiments of the disclosure uses the half wave plate to convert the polarization state of the backlight source to be consistent with the viewing angle modulation layer, thereby improving the modulation efficiency of the viewing angle modulation layer, and effectively increasing the brightness of the display device.

In order to make the forgoing features and advantages of the disclosure more comprehensible, embodiments are given below and described in detail with reference to the accompanying drawings.

### BRIEF DESCRIPTION OF THE DRAWINGS

FIG. 1A shows a schematic diagram of a display device according to some embodiments of the disclosure, and FIG. 1B shows a schematic diagram of a viewing angle modulation layer in the display device shown in FIG. 1A according to an embodiment of the disclosure.

FIG. 2 shows a schematic diagram of a display device according to some embodiments of the disclosure.

FIG. 3 shows a schematic diagram of a display device according to some embodiments of the disclosure.

### DESCRIPTION OF THE EMBODIMENTS

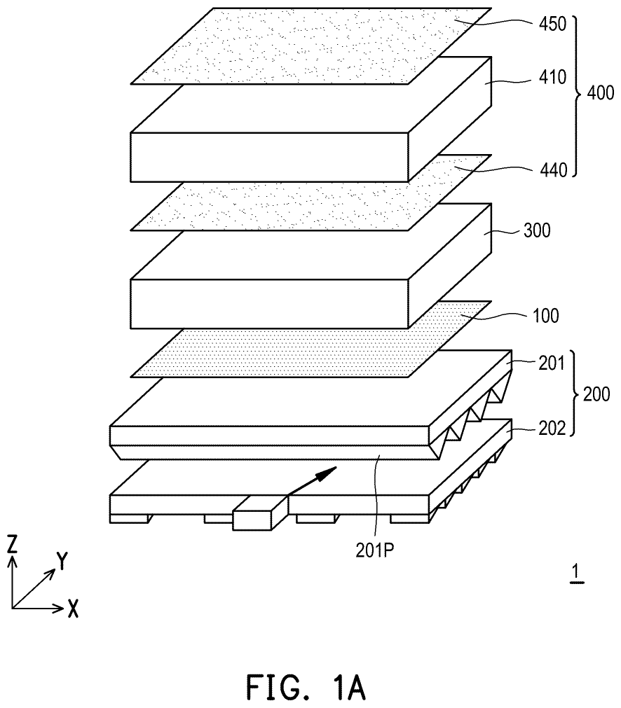

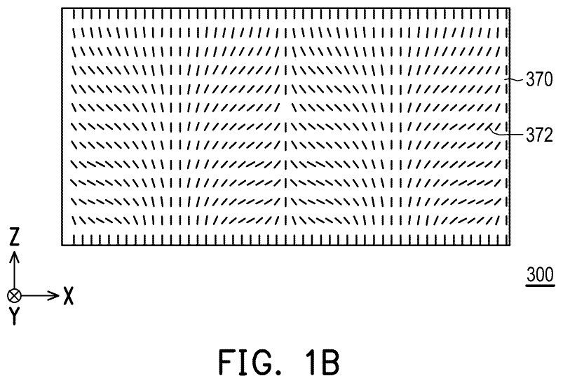

Referring to FIG. 1A and FIG. 1B, FIG. 1A shows a schematic diagram of a display device according to some embodiments of the disclosure. FIG. 1B shows a schematic diagram of a viewing angle modulation layer in the display device shown in FIG. 1A according to an embodiment of the disclosure.

A display device 1 includes a backlight module 200, a half wave plate 100, a viewing angle modulation layer 300, and a display panel 400 stacked in sequence along a Z direction.

The display panel 400 includes a polarizer 440, a pixel layer 410, and a polarizer 450 stacked in sequence, in which an absorption axis of the polarizer 440 is parallel to a Y direction and a transmission axis is parallel to an X direction, an absorption axis of the polarizer 450 is parallel to the X direction and a transmission axis is parallel to the Y direction, and the X direction, the Y direction, and the Z direction are perpendicular to each other.

The viewing angle modulation layer 300 includes a liquid crystal layer 370, and the liquid crystal layer 370 includes liquid crystal molecules 372. An alignment film (not shown) may be used to provide anchoring energy, and an electrode layer (not shown) may be used to control the direction of each liquid crystal molecule 372, in order to control the viewing angle of the display device 1.

The backlight module 200 includes a prism sheet 201 and a surface light source 202. The prism sheet 201 includes a plurality of prism structures 201P. The prism sheet 201 may be an inverse prism, for example, but the disclosure is not limited thereto. The prism structures 201P are sequentially arranged along the Y direction, and each prism structure 201P extends along the X direction. The cross-sectional diagram of the prism sheet 201 on a Y-Z plane has a zigzag shape. The surface light source 202 may include multiple components such as light-emitting diodes, light guide plates, and optical films, and may be a side-entry light source as shown in FIG. 1, but the disclosure is not limited thereto.

It should be noted that since the structure of the prism sheet 201 is directional, the light coming from the surface light source 202 and penetrating the prism sheet 201 has non-uniformity in the electric field. Specifically, the electric field of the light coming from the backlight module 200 in the Y direction is stronger than the electric field in the X direction, that is to say, the component of the polarization state thereof in the Y direction is greater than the component in the X direction. In other words, in the light coming from the backlight module 200, the intensity of the Y-direction linear polarization is significantly greater than the intensity of the X-direction linear polarization. In some embodiments, in the light coming from the backlight module 200, before the light enters the half wave plate 100, a ratio of the intensity of the Y-direction linear polarization to the intensity of the X-direction linear polarization is in a range of 1.23 to 2.34, but the disclosure is not limited thereto. Accordingly, the display device 1 provided in this embodiment is configured with the half wave plate 100, in which the slow axis of the half wave plate 100 is configured to be not parallel to the X direction, and not perpendicular to the X direction, in order to change the polarization state of the light coming from the backlight module 200, so that the changed polarization state may be consistent with the viewing angle modulation layer 300 and the polarizer 440, thereby increasing the brightness of the display device 1. In an embodiment, the brightness of the display device 1 disposed with the half wave plate 100 is increased by 12% compared to a display device without the half wave plate 100 according to a comparative example.

Specifically, in an embodiment, the electrode layer (not shown) of the viewing angle modulation layer 300 includes a plurality of electrodes sequentially arranged along the X direction and electrically insulated from each other, and each electrode has a long strip shape extending along the Y direction. Therefore, when the liquid crystal molecules 372 in the liquid crystal layer 370 are driven by the electric field through the electrodes, the liquid crystal molecules 372 in the liquid crystal layer 370 may be arranged as shown in FIG. 1B. The long axis of each liquid crystal molecule 372 is parallel to an X-Z plane, and the long axes of the multiple liquid crystal molecules 372 are inclined with respect to the Z direction. In such a situation, the viewing angle modulation layer 300 has a viewing angle modulation function for the linear polarization of the electric field in the X direction, and has almost no viewing angle modulation function for the linear polarization of the electric field in the Y direction. Therefore, in this embodiment, the slow axis of the half wave plate 100 may be configured to have an included angle of 45 degrees (or 225 degrees) with the X direction, and to have an included angle of 45 degrees (or 135 degrees) with the Y direction, so as to convert the Y-direction linear polarization in the light coming from the backlight module 200 into the X-direction linear polarization, thereby optimizing the viewing angle modulation efficiency of the viewing angle modulation layer 300, and improving the transmittance of the polarizer 440.

In an embodiment, there is only one film, the prism sheet 201, with the prism structures 201P in the display device 1, and the display device 1 does not have other films with the prism structures 201P. In such a situation, the non-uniformity in the electric field significantly exists in the light coming from the backlight module 200. Therefore, by configuring the slow axis of the half wave plate 100 to have an included angle of 45 degrees (or 225 degrees) with the X direction, and to have an included angle of 45 degrees (or 135 degrees) with the Y direction, the Y-direction linear polarization with greater intensity may be converted into the X-direction linear polarization. That is to say, before the light enters the viewing angle modulation layer 300, the electric field strength thereof in the X direction is greater than the electric field strength in other directions. Accordingly, through this operation, the viewing angle modulation efficiency of the viewing angle modulation layer 300 can be maximized, and the transmittance of the polarizer 440 can be improved.

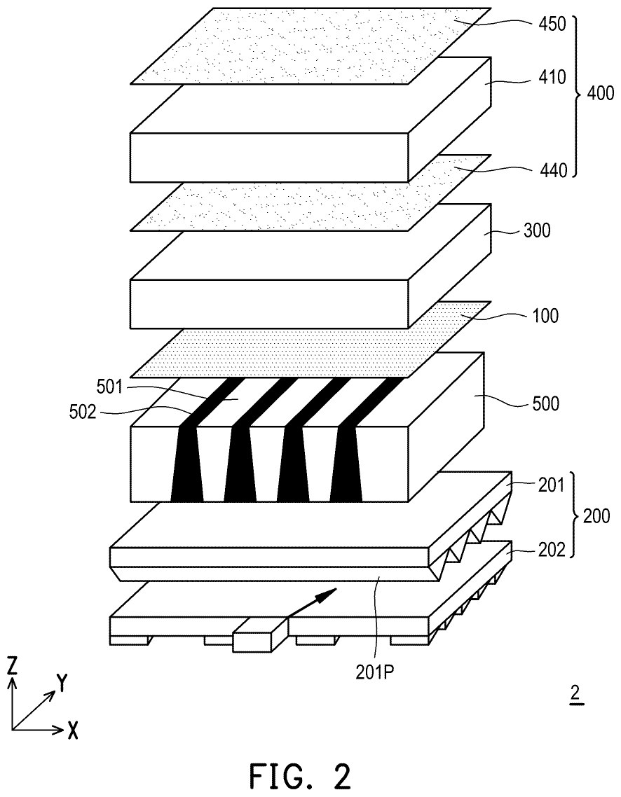

In order to fully explain various implementation manners of the disclosure, other embodiments of the disclosure will be described below. It should be noted that the following embodiments follow the reference signs and part of the content of the previous embodiments, in which the same reference signs are used to represent the same or similar elements, and descriptions of the same technical content are omitted. For descriptions of omitted parts, reference may be made to the foregoing embodiments, so details will not be repeated in the following embodiments. Referring to FIG. 2, which shows a schematic diagram of a display device according to some embodiments of the disclosure.

A display device 2 includes a backlight module 200, an anti-peeping filter 500, a half wave plate 100, a viewing angle modulation layer 300, and a display panel 400 stacked in sequence along the Z direction.

The difference between the display device 2 in this embodiment and the display device 1 is that the display device 2 is disposed with an anti-peeping filter 500, in which the anti-peeping filter 500 is disposed between the backlight module 200 and the half wave plate 100 to provide an anti-peeping function. The anti-peeping filter 500 includes a plurality of light-blocking structures 502 sequentially arranged along the X direction and extending toward the Y direction, and light-transmitting structures 501 between the light-blocking structures 502, in which each light-blocking structure 502 may be a columnar structure extending in the Y direction.

The prism sheet 201 in the display device 2 has the same structure as the prism sheet 201 in the display device 1. In such a configuration, since the structure of the prism sheet 201 is directional and the structure of the anti-peeping filter 500 is directional, the light coming from the surface light source 202 and sequentially penetrating the prism sheet 201 and the anti-peeping filter 500 has non-uniformity of the electric field, and the intensity of the Y-direction linear polarization is significantly greater than the intensity of the X-direction linear polarization.

The display device 2 provided in this embodiment is configured with the half wave plate 100, in which the slow axis of the half wave plate 100 is configured to be not parallel to the X direction, and not perpendicular to the X direction, in order to change the polarization state of the light coming from the backlight module 200 and the anti-peeping filter 500, so that the changed polarization state may be consistent with the viewing angle modulation layer 300 and the polarizer 440, thereby increasing the brightness of the display device 2.

In an embodiment, the slow axis of the half wave plate 100 may be configured to have an included angle of 45 degrees (or 225 degrees) with the X direction, and to have an included angle of 45 degrees (or 135 degrees) with the Y direction, so as to convert the Y-direction linear polarization in the light coming from the backlight module 200 and the anti-peeping filter 500 into the X-direction linear polarization, thereby optimizing the viewing angle modulation efficiency of the viewing angle modulation layer 300.

It should also be noted that, compared with the display device 1 that is not provided with the anti-peeping filter 500, the display device 2 of this embodiment further has a light collimation function. Compared with the display device 1, the display device 2 has improved the anti-peep function.

In an embodiment, the anti-peeping filter 500 and the half wave plate 100 in the display device 2 may be bonded to avoid interface reflection between the anti-peeping filter 500 and the half wave plate 100 to further optimize the optical performance of the display device 2.

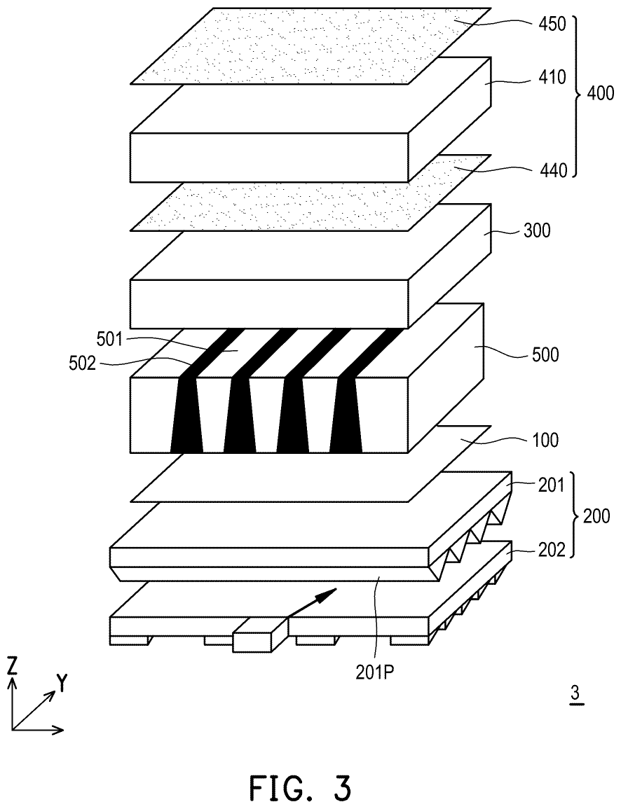

According to some embodiments of the disclosure, the positions of the anti-peeping filter 500 and the half wave plate 100 in the display device 2 may be interchanged to form the display device 3 as shown in FIG. 3. In the display device 3, the anti-peeping filter 500 is disposed between the half wave plate 100 and the viewing angle modulation layer 300. By disposing the anti-peeping filter 500, the display device 3 may be implemented as an anti-peeping display device. By disposing the half wave plate 100, the optical performance of the display device 3 is good. In an embodiment, the anti-peeping filter 500 and the half wave plate 100 in the display device 3 may be bonded to avoid interface reflection between the anti-peeping filter 500 and the half wave plate 100 to further optimize the optical performance of the display device 3.

In summary, the display device provided by the embodiments of the disclosure uses the half wave plate to convert the polarization state of the backlight source to be consistent with the viewing angle modulation layer, thereby improving the modulation efficiency of the viewing angle modulation layer, and effectively increasing the brightness of the display device.

What is claimed is:

1. A display device, comprising a backlight module, a half wave plate, a viewing angle modulation layer, and a display panel stacked in sequence, wherein
the display panel comprises a first polarizer, a pixel layer, and a second polarizer stacked in sequence, and the first polarizer is disposed between the viewing angle modulation layer and the pixel layer,
the backlight module comprises a prism sheet, and the prism sheet comprises a plurality of prism structures arranged along a first direction, and
the half wave plate has a slow axis, the slow axis is parallel to a second direction, and the first direction is not parallel to, and not perpendicular to, the second direction.

2. The display device as claimed in claim 1, wherein each of the prism structures extends toward a third direction, and the third direction is perpendicular to the first direction.

3. The display device as claimed in claim 1, wherein a transmission axis of the first polarizer is perpendicular to the first direction.

4. The display device as claimed in claim 1, wherein an included angle between the first direction and the second direction is 45 degrees or 135 degrees.

5. The display device as claimed in claim 1, wherein there is only one film with the prism structures in the display device.

6. The display device as claimed in claim 1, wherein the prism sheet is an inverse prism sheet.

7. The display device as claimed in claim 2, further comprising an anti-peeping filter disposed between the backlight module and the viewing angle modulation layer, wherein the anti-peeping filter comprises a plurality of light-blocking structures arranged along the third direction and extending toward the first direction.

8. The display device as claimed in claim 7, wherein the anti-peeping filter is bonded to the half wave plate.

9. The display device as claimed in claim 7, wherein the anti-peeping filter is disposed between the half wave plate and the viewing angle modulation layer.

10. The display device as claimed in claim 7, wherein the anti-peeping filter is disposed between the half wave plate and the backlight module.

11. The display device as claimed in claim 1, wherein the viewing angle modulation layer comprises liquid crystal molecules.

12. A display device, comprising a backlight module, a half wave plate, a viewing angle modulation layer, a first polarizer, a pixel layer, and a second polarizer stacked in sequence, wherein
the first polarizer has a transmission axis, and the transmission axis is parallel to a first direction,
light provided by the backlight module has a first intensity and a second intensity before entering the half wave plate, the first intensity is an intensity of a first part of the light, the second intensity is an intensity of a second part of the light, a polarization direction of the first part of the light is parallel to the first direction, a polarization direction of the second part of the light is parallel to a second direction, the second direction is perpendicular to the first direction, and a ratio of the second intensity to the first intensity is in a range of 1.23 to 2.34, and
the half wave plate has a slow axis, the slow axis is parallel to a third direction, and the first direction is not parallel to, and not perpendicular to, the third direction.

13. The display device as claimed in claim 12, wherein the backlight module comprises a prism sheet, the prism sheet comprises a plurality of prism structures arranged along the second direction, and each of the prism structures extends toward the first direction.

14. The display device as claimed in claim 13, wherein there is only one film with the prism structures in the display device.

15. The display device as claimed in claim 13, wherein the prism sheet is an inverse prism sheet.

16. The display device as claimed in claim 12, wherein an included angle between the first direction and the third direction is 45 degrees or 225 degrees.

17. The display device as claimed in claim 13, further comprising an anti-peeping filter disposed between the backlight module and the viewing angle modulation layer, wherein the anti-peeping filter comprises a plurality of light-blocking structures arranged along the first direction and extending toward the second direction.

18. The display device as claimed in claim 17, wherein the anti-peeping filter is bonded to the half wave plate.

19. The display device as claimed in claim 17, wherein the anti-peeping filter is disposed between the half wave plate and the viewing angle modulation layer.

20. The display device as claimed in claim 17, wherein the anti-peeping filter is disposed between the half wave plate and the backlight module.
